(19) United States
(12) Patent Application Publication
(10) Pub. No.: US 2026/0201255 A1
(43) Pub. Date: Jul. 16, 2026

(54) PROCESS AND PLANT FOR PRODUCING HYDROCARBONS FROM LIQUID OILS

(71) Applicant: TOPSOE A/S, Kgs. Lyngby (DK)

(72) Inventor: Stefan ANDERSEN, Kgs. Lyngby (DK)

(73) Assignee: TOPSOE A/S, Kgs. Lyngby (DK)

(21) Appl. No.: 19/136,704

(22) PCT Filed: Jan. 11, 2024
(86) PCT No.: PCT/EP2024/050524

§ 371 Date: Jun. 6, 2025

(30) Foreign Application Priority Data
Jan. 24, 2023 (EP) 23153003.1

(51) Int. Cl. C10G 45/02; B01J 8/04; C01B 3/384

(52) U.S. Cl. CPC C10G 45/02; B01J 8/0492; B01J 8/0496; C01B 3/384; B01J 2208/00256; B01J 2208/00398; B01J 2208/00504; C01B 2203/0233; C01B 2203/065; C01B 2203/085; C10G 2300/202

(57) ABSTRACT

Process and plant for producing a hydrocarbon product, the process including the steps of: i) conducting a liquid oil stream to a hydroprocessing step for producing a first and second liquid hydrotreated streams, and ii) separating from the first or second liquid hydrotreated stream, optionally from said main hydrotreated stream, said hydrocarbon product.

The present invention relates to a process and plant for producing a hydrocarbon product such as jet fuel, diesel, or naphtha, from a liquid oil stream such as a pyrolysis oil stream or a hydrothermal liquefaction oil (HTL oil) stream.

In the hydroprocessing of hydrocarbon feeds comprising a significant amount of oxygenates, such as a pyrolysis oil and HTL oil, the hydrocarbon product resulting from the hydroprocessing, in particular from the hydrodeoxygenation (HDO) step, may still contain large amount of oxygenates. These remaining oxygenates represent an enormous challenge for the HDO itself and impairs also integration with a hydrogen producing unit (HPU) downstream for producing make-up hydrogen used in the process and plant.

The oxygen (O) content of a liquid oil stream, such as a pyrolysis oil and HTL oil, which is in the range 5-50 wt %, needs to be decreased before it can be used as a hydrocarbon product (hydrocarbon fuel). For instance, the oxygen content of a HTL oil may be 5-10%; the oxygen content of a pyrolysis oil may be up to 50%. The oxygen is generally removed by hydroprocessing in a HDO reactor using high pressure (50-200 bar) and high temperature (350-400° C.). However, the liquid oil stream is very unstable and when heated it tends to polymerize, which leads to rapid catalyst deactivation and plugging of the HDO reactor, due to coking. It is therefore known to stabilize the liquid oil stream prior to the HDO step, for instance as described in applicant's WO 2022152900.

Typically, in connection with hydroprocessing of hydrocarbon feeds, the hydrotreated stream from the HDO is sent to a hot separator or a hydrogen stripper for dividing the hydrotreated stream into a vapor stream and a liquid stream. The vapor stream is further cooled, mixed with wash water and then sent to a cold separator. From the cold separator, a sour water stream is withdrawn, as well as an overhead gas which may be recycled to the hydroprocessing. Also, a hydrocarbon liquid stream is withdrawn. The latter is then separated into the desired hydrocarbon products, such as jet fuel, diesel, or naphtha.

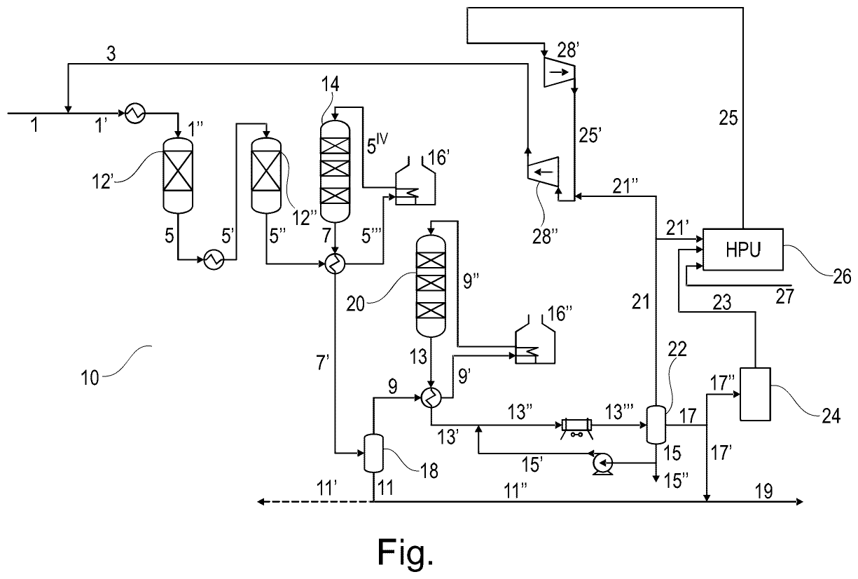

For instance, US2009082603 A1 discloses a process for producing diesel boiling range fuel and fuel blending component from renewable feedstocks. Hydrogenation and deoxygenation are performed in one or more reactors. A vapor stream is separated from the reaction zone effluent, and carbon dioxide is separated from the vapor stream. FIG. 2 of this citation discloses a hydrodeoxygenation (HDO) unit 204 in which the entire first hydrotreated stream from first HDO zone 204a is further hydrotreated in second HDO zone 204 b. A hydrotreated effluent stream 206 is withdrawn with no subsequent separation thereof of a vapor stream which is conducted to a second HDO unit.

US2013305593 A1 discloses a hydroprocessing process in which a separation process includes a modified enhanced hot separator system. The modified enhanced hot separator system combines a hot separator with a hot stripping column.

Applicant's WO 2021/180805 A1 (e.g. FIG. 2 therein) discloses a process and plant in which a renewable feed is directed to a first catalytic hydrotreating unit (HDO) and then to a high pressure separator such as HP stripper located downstream. A recycle oil from the HP stripper is combined with the renewable feed. Off-gas generated from the final separation of hydrocarbons is sent to a hydrogen producing unit (HPU) for producing make-up hydrogen. Other prior art is disclosed in GB 2601407 and applicant's WO 2020043758.

Applicant has found that the hydrocarbon liquid stream from the cold separator still contains oxygenates, which means a yield loss of carbon to the water phase and further it is not possible to utilize the cold separator vapor or liquid for hydrogen production. In addition, oxygenates are carried over in the sour-water withdrawn from the cold separator as well as in off-gas removed from overhead gas from the cold separator.

Accordingly, in a general embodiment according to a first aspect of the invention, there is provided a process for producing a hydrocarbon product, said process comprising the steps of:
i) conducting a liquid oil stream to a hydroprocessing step for producing a first and second liquid hydrotreated streams, said hydroprocessing step comprising:
i-1) optionally, conducting the liquid oil stream to a stabilization step in a stabilization reaction zone for producing a stabilized liquid oil stream;
i-2) conducting the liquid oil stream, or the optional stabilized liquid oil stream, to a first hydrodeoxygenation (HDO) step in a HDO reaction zone for producing a first hydrotreated stream;
i-3) conducting the first hydrotreated stream to a first separation unit for splitting said first hydrotreated stream into a vapor stream and said first liquid hydrotreated stream;
i-4) conducting the vapor stream to a second hydrodeoxygenation (HDO) step in a HDO reaction zone for producing a second hydrotreated stream;
i-5) cooling the second hydrotreated stream for providing a cooled second hydrotreated stream, conducting the cooled second hydrotreated stream to a second separation unit and separating therefrom at least an overhead gas stream and said second liquid hydrotreated stream;
i-6) optionally, combining the first liquid hydrotreated stream with the second liquid hydrotreated stream into a main hydrotreated stream;
ii) separating from the first or second liquid hydrotreated stream, optionally from said main hydrotreat stream, said hydrocarbon product.

For instance, said process comprises the steps of:
i) conducting a liquid oil stream to a hydroprocessing step for producing a main hydrotreated stream, said hydroprocessing step comprising:
i-1) optionally conducting the liquid oil stream to a stabilization step in a stabilization reaction zone for producing a stabilized liquid oil stream;
i-2) conducting the liquid oil stream, or the optional stabilized liquid oil stream, to a first hydrodeoxygenation (HDO) step in a HDO reaction zone for producing a first hydrotreated stream;
i-3) conducting the first hydrotreated stream to a first separation unit, e.g. a hot separator, for splitting said first hydrotreated stream into a vapor stream and a first liquid hydrotreated stream;
i-4) conducting the vapor stream to a second hydrodeoxygenation (HDO) step in a HDO reaction zone for producing a second hydrotreated stream;
i-5) cooling the second hydrotreated stream, conducting it to a second separation unit, e.g. a cold separator, and separating therefrom at least an overhead gas stream and a second liquid hydrotreated stream;
i-6) combining the first liquid hydrotreated stream with the second liquid hydrotreated stream into said main hydrotreated stream;
ii) separating from the main hydrotreated stream said hydrocarbon product.

The term “first aspect” or “first aspect of the invention” means the process according to the invention. The term “second aspect” or “second aspect of the invention” means the plant, i.e. process plant (system), according to the invention.

The term “comprising” includes “comprising only”, i.e. “consisting of”.

The term “reaction zone” means a physically delimited section in which a reaction takes place. For instance, a reaction zone is a catalytic zone. For instance, the catalytic zone is a catalytic fixed bed. For instance, a reaction zone is a reactor. Thus, a stabilization reaction zone is for instance a stabilization reactor. A HDO reaction zone is for instance a HDO reactor. It would also be understood that a reactor may have one or more reaction zones, such as one or more catalytic fixed beds arranged in series.

The term “a stabilization reaction zone” means one or more stabilization reaction zones, for instance one or more stabilization reactors, such as one or more stabilization reactors arranged in series.

The term “a HDO reaction zone” means one or more HDO reaction zones, for instance one or more HDO reactors, such as one or more HDO reactors arranged in series.

The term “a hydrocarbon product” means one or more hydrocarbon products. A hydrocarbon product is for instance jet fuel or diesel. A hydrocarbon product is for instance also naphtha.

The term “conducting” means “supplying”.

The term “suitably” means “optionally”, i.e. an optional embodiment.

The term “present invention” or simply “invention” may be used interchangeably with the term “present application” or simply “application”.

The HDO reaction zone in step i-2) is also denoted herein as “main HDO”.

The HDO reaction zone in step i-4) is also denoted herein as “vapor HDO”.

The term “and/or” means in connection with a given embodiment any of three options.

The term “and/or” may be used interchangeably with the term “at least one of” the three options.

The term “at least a portion of” a certain stream, means the entire stream or a portion (fraction) thereof.

The use of the article “a” or “an” means at least one.

Other definitions are provided in connection with one or more of below embodiments.

The invention enables a significant reduction in in the yield loss of carbon to the water phase in the second separation unit, e.g. cold separator, of step i-5; the yield difference being 1-2 wt % total liquid product, and thus representing a significant difference for an industrial process or plant producing the hydrocarbons. In addition, the invention enables integration with a hydrogen producing unit (HPU), as it will become apparent from below embodiments, and which is suitably arranged downstream for producing make-up hydrogen gas which is used in the process, since gaseous hydrocarbon streams produced in the process may be fed to the HPU, thereby further enabling to increase the yield of carbon of the process and plant, as well as enabling internally sourcing the make-up hydrogen gas. Furthermore, more inexpensive materials may now be provided downstream of the HDO reactor of step i-4), i.e. vapor HDO, due to the oxygenate removal, and not least, since oxygenates are eliminated, simulation of the process without the presence of oxygenates becomes much simpler and more reliable, thereby also enabling better control and operation of the process and plant for which conditions may be based on such simulations. Moreover, as it also will become apparent from a below embodiment, the invention provides for easier cleaning in a waste-water treatment plant of sour-water produced in the process, e.g. in said step i-5).

In an embodiment, the first separation unit is a hot separator and/or a stripping unit such as a high-pressure stripper (HP stripper); and the second separation unit is a cold separator.

Hence:
In an embodiment, the first separation unit is a hot separator. As is well-known in the art, a hot separator is a vapor-liquid separator, e.g. a vessel, and operated at temperatures in the range 40-400° C., such as 150-280° C., while maintaining the hydrocarbon components for downstream separation into the hydrocarbon products, in the liquid form. The hot separator operates in the pressure range 5-150 barg, suitably 40-120 barg. Oxygenate compounds left over from the prior HDO step, i.e. the main HDO, such as carbonyls, alcohols or organic acids, are carried over in the vapor stream. Heat may also be supplied to product equipment, such as valves and pipes, to prevent clogging.
In another embodiment, the first separation unit is a stripping unit, such as HP stripper, e.g. a hot high pressure stripping column. As is well-known in the art, the term “HP stripper” means a high-pressure stripper, where gaseous components of the first hydrotreated stream are stripped from the liquid components, including also highly corrosive components such as HCl. Suitably the HP stripper operates at the same pressure and temperatures as the hot separator, thus in the pressure range 5-150 barg, suitably 40-120 barg. Suitably, the temperatures are in the range 30-400° C. such as 200-300° C. The HP stripper enables the separation by means of a stripping medium, suitably hydrogen, e.g. make up hydrogen gas.

The term “barg”, denotes as is well known, the pressure in bar above atmospheric pressure, the atmospheric pressure being about 1 bar.
In yet another embodiment, the first separation unit is a hot separator and a HP stripper. Hence, the first separation unit is a combination of a hot separator and a HP stripper. Thereby, the plot size and attendant cost is reduced, as the HP stripper can be made smaller. The cost of the hot separator and a smaller HP stripper is lower than the cost of an original stand-alone HP stripper. The requirements for any stripping medium in the second separation unit are also reduced.
In yet another embodiment, the second separation unit is a cold separator, such as high-pressure cold separator (HPCS), also referred to as cold high-pressure separator (CHPS). As is well-known in the art, a cold separator is a product separator in which a cooled feed to which wash water may have been added is provided, and the cooled feed is separated into an overhead gas stream and a liquid stream, i.e. liquid hydrotreated stream, optionally also into a water stream as a by-product. The water stream is normally also referred to as sour water, as it may contain sulfur and nitrogen containing compounds, such as H₂S and NH₃, and for the feeds according to the present invention (liquid oils), also oxygen-containing compounds such as CO₂.

Suitably, a portion of the first liquid hydrotreated stream is recycled to main HDO reaction zone. Thereby, further integration of process and plant is provided.

In an embodiment, the process further comprises:
dividing a portion of the overhead gas stream of step i-5) as an off-gas stream and supplying the off-gas stream to a hydrogen producing unit (HPU) comprising a reforming unit, for producing a make-up hydrogen stream;

and/or
recycling another portion of the overhead gas stream of step i-5), optionally in admixture with at least a portion of make-up hydrogen stream, to any of: optional stabilization reaction zone of step i-1), HDO reaction zone of step i-2), HDO reaction zone of strep i-4), and combinations thereof.

Thereby, a highly synergistic integration is achieved. The overhead gas recycle is rich in hydrogen as well as light hydrocarbon compounds such as CH₄, and may also comprise H₂S. This is advantageous for any of the hydroprocessing steps upstream, as these require the presence of hydrogen and may also require sulfur to keep the catalysts for stabilization and/or HDO in sulfided form. There is no need of externally sourcing hydrogen and a sulfur agent such as dimethyl disulfide (DMDS) or similar, as the liquid oil stream being fed to the process and plant is suitably from a renewable source and thus lacks sulfur compared to fossil fuel sources. In addition, the make-up hydrogen stream is suitably generated in the HPU by supplying a minor side-stream generated in the process, namely said off-gas stream. This off-gas stream is supplied as at least part of the hydrocarbon feed to the HPU.

In a particular embodiment, said another portion of the overhead gas stream of step i-5) being recycled, is not subjected to a separation step for removing H₂S and/or CO₂, optionally also for removing NH₃ and/or CO, prior to being conducted to said any of: stabilization reaction zone of step i-1), HDO reaction zone of step i-2), HDO reaction zone of strep i-4), and combinations thereof.

Hence, in an embodiment, the another portion of the overhead gas stream of step i-5) is directly recycled to said any of: stabilization reaction zone of step i-1), HDO reaction zone of step i-2), HDO reaction zone of strep i-4), and combinations thereof. It would be understood that the term “directly recycled” means untreated or without subjecting it to a step, such as a separation step, changing its composition, other than by admixing with make-up hydrogen.

The hydrocarbon feed to the HPU may also comprise other hydrocarbon feed sources, such as:
natural gas;
naphtha produced in the process and plant, such as naphtha as hydrocarbon product separated in said step ii) i.e. separating from the main hydrotreated stream said hydrocarbon product;
other light end hydrocarbons, such as an LPG stream (liquified petroleum gas), i.e. a C3-C4 hydrocarbon stream or a fuel gas stream containing C1-C4 hydrocarbons, produced in the process and plant; such as in said step ii).

The provision of such internally sourced hydrocarbon sources, other than natural gas which is externally sourced, significantly reduces the need of the latter as source of hydrocarbon feed to the HPU. Reducing natural gas import also reduces the carbon intensity i.e. CO₂ emission factor of the process/plant, since a “green” feed is used as fuel for the HPU instead of the “grey” natural gas.

Suitably, said step ii), i.e. separating from the main hydrotreated stream said hydrocarbon product, comprises conducting the main hydrotreated stream to a product stripper for producing:
an overhead gas fraction comprising naphtha (i.e. hydrocarbons boiling the in the naphtha boiling range) and C1-C4 hydrocarbons;
a bottom fraction comprising any of diesel, jet fuel, or combinations thereof as the hydrocarbon product.

Suitably, step ii) further comprises the overhead gas fraction from the product stripper being further conducted to a fractionation step in a fractionation unit, e.g. a distillation column, for producing an overhead gas comprising said C3-C4 hydrocarbons as an LPG stream; said fuel gas stream containing C1-C4 hydrocarbons, such as a C1-C2 fuel gas stream; and a bottom stream as said naphtha.

It would be understood that the term “naphtha” means hydrocarbons boiling in the naphtha boiling range; the term “diesel” means hydrocarbons boiling in the diesel fuel boiling range; the term “jet fuel” means hydrocarbons boiling in the jet fuel boiling range. These hydrocarbon products boil at above 50° C.

In an embodiment, the reforming unit of said HPU is an electrically heated steam methane reformer (e-SMR). This reforming unit is particularly advantageous for i.a. the above-mentioned minor side streams used as hydrocarbon feed sources to the HPU. The e-SMR is compact, thus enabling a small plot size, and is powered by renewable sources, such as wind, solar, or hydro (hydropower). The e-SMR may also be powered by a thermonuclear source. Thereby, CO₂ emissions associated with the reforming of the HPU are also eliminated.

In another embodiment, the steam reforming unit is: a convection reformer, a tubular reformer, autothermal reformer (ATR), electrically heated steam methane reformer (e-SMR), or combinations thereof.

For details on the HPU and the above reforming units, reference is given to the above mentioned applicant's WO 2021/180805 A1. For particular details on the e-SMR, reference is given to in particular applicant's WO 2019/228797 A1.

In an embodiment, the process further comprises:
pre-heating in step i-2) the optional stabilized liquid oil stream to inlet temperature of said HDO reaction zone in a fired heater;
preheating in step i-4) the vapor stream to inlet temperature of said HDO reaction zone in a fired heater;
and wherein said preheating is provided in the same fired heater, i.e. in a common fired heater.

This enables heat integration and saves thereby at least the need of one fired heater, for instance the fired heater associated to the vapor HDO. A fired heater is a unit which requires significant plot size and also conveys significant capital and operating expenses. A hydrocarbon fuel such as natural gas is normally also provided for combustion therein and thereby generation of the heat in the fired heater. CO₂ emissions in the resulting flue gas are thus generated. Hence, obviating a fired heater reduces also the need for a hydrocarbon fuel such as natural gas and reduces the associated CO₂ emissions, as well as any other posttreatment required for the flue gas generated in the fired heater.

In an embodiment, the process further comprises:
pre-heating in step i-2) the optional stabilized liquid oil stream to inlet temperature of said HDO reaction zone in an electrical heater.

As is well-known, an electrical heater is a heating device or heating unit that converts electrical current to heat e.g. by resistors that provide radiant energy. The electrical heater is powered by renewable sources, such as wind, solar, or hydro (hydropower). The electrical heater may also be powered by a thermonuclear source. Thereby, CO₂ emissions associated with the heating, and which would normally require the use of a fired heater, are eliminated.

In an embodiment, the process comprises:
preheating in step i-4) the vapor stream to inlet temperature of said HDO reaction zone by heat exchange with the first hydrotreated stream of step i-2); i.e. the HDO inlet of step i-4) is preheated by heat exchange with the HDO outlet of step i-2).

This enables also heat integration and saves the need of providing a fired heater associated to the vapor HDO.

Suitably, the HDO reaction zone in step i-2) (main HDO) and i-4) (vapor HDO) is operated at a higher temperature and equal or lower pressure than the optional stabilization reaction zone of step i-1). Suitably also, the vapor HDO is operated at equal or lower temperature than the main HDO.

Suitably, the stabilization reaction zone is a stabilization reactor in which the liquid oil stream is reacted with hydrogen in the presence of a nickel-molybdenum (Ni—Mo) based catalyst at a temperature of 20-240° C., a pressure of 100-200 barg, and a liquid hourly space velocity (LHSV) of 0.1-1.1 h⁻¹. The hydrogen to liquid oil ratio is for instance 1000-6000 NL/L, such as 2000-5000 NL/L, for instance 2500, 3000, 3500, 4000 or 4500 NL/L. The term “hydrogen to liquid oil ratio” or “H₂/oil ratio” means the volume ratio of hydrogen to the flow of the liquid oil stream. For details, reference is given to applicant's WO 2022152900.

It would be understood that the unit NL means “normal” liter, i.e. the amount of gas taken up this volume at 0° C. and 1 atmosphere.

During the hydrotreating of liquid oil, the oxygen is mainly removed as H₂O, which gives normally a paraffinic fuel consisting of paraffins. This is called the hydrodeoxygenation (HDO) pathway. Oxygen can also be removed by dicarboxylic (DCO) pathway, which generates CO₂ instead of H₂O:
HDO pathway: C₁₇H₃₄COOH+3.5H₂↔18H₃₈+2H₂O
Decarboxylation pathway: C₁₇H₃₄COOH+0.5H₂↔C₁₇H₃₆+CO₂

When stabilizing the liquid oil stream, alcohols and among other, acids e.g. fatty acids therein, are converted: alcohols may be converted to their respective alkanes or unsaturated organic compounds and thereafter hydrogenated to the respective alkanes; acids and other compounds comprising a carbonyl group such as aldehydes and ketones are first converted by hydrogenation to their respective alcohols and these may later be converted to alkanes as explained above. In the stabilization, the oxygen atom in the carbonyl group of a given organic compound may be removed as H₂O or CO, per the above recited HDO and DCO reaction pathways.

Remaining alcohols and acids or other compounds having carbonyl groups from the stabilization would then be converted to paraffins in the subsequent HDO step, per the recited reaction HDO and DCO pathways.

Similarly, oxygenates which were not removed in the main HDO and which are now collected in the vapor stream from the first separation unit, e.g. hot separator, or high-pressure stripper, are finally removed in the vapor HDO.

The material catalytically active in hydrotreating, e.g. HDO, typically comprises an active metal (sulfided base metals such as nickel, cobalt, tungsten and/or molybdenum, but possibly also either elemental noble metals such as platinum and/or palladium) and a refractory support (such as alumina, silica or titania, or combinations thereof).

Hydrotreating, herein referred to as HDO conditions, involve a temperature in the interval 250-400° C., such as said 300-400° C., a pressure in the interval 30-250 bar, such as said 50-200 bar, and a liquid hourly space velocity (LHSV) in the interval 0.1-2, optionally together with intermediate cooling by quenching with cold hydrogen, feed or product

In an embodiment, step i-5) comprises separating a water stream from the second separation unit, e.g. cold separator, admixing a portion thereof as wash-water with the second hydrotreated stream, and conducting it to a cooling unit, e.g. an air-cooler, for providing said cooled second hydrotreated stream, prior to it being introduced to the second separation unit.

Any oxygenates being left over in the first hydrotreated stream are carried over in the vapor from the first separation unit, e.g. hot separator, and thus eliminated prior to entering e.g. the cold separator. As another portion of the water stream from the cold separator is separated as sour-water, it needs to be further treated in a waste water treatment plant. The present application enables avoiding the carrying over of any oxygenates in the sour-water and thus provides for easier cleaning in the waste-water treatment plant. The presence of oxygenates in the wastewater is undesirable, as these are difficult to remove and thus convey high capital and operating expenses in connection with the wastewater treatment plant. The present application avoids also the carrying over of any oxygenates in the above-mentioned off-gas stream divided from the overhead gas stream withdrawn from the cold separator. The presence of oxygenates in the off-gas stream is also undesirable as this stream is supplied to the HPU, in particular to the reforming unit therein. The associated cleaning of hydrocarbon feed (fuel) gas being supplied, for instance the requirements of a cleaning unit in the HPU upstream the reforming unit, is significantly reduced.

For the purposes of the present application, the term “oxygenates” means at least one of alcohols, ethers, aldehydes and ketones, carboxylic acids and esters. Alcohols, such methanol and ethanol are common by-products in hydroprocessing processes and can be carried over in the hydrocarbon feed sent to the HPU. These can react with catalysts in the steam methane reformer of the HPU and form unwanted products, potentially reducing the efficiency of the reforming process. Ethers such as dimethyl ether (DME) and diethyl ether (DEE) can also be present, which can decompose to form alkanes and water, which can affect the steam-to-carbon molar ratio in the reforming. Aldehydes and ketones are also produced in hydroprocessing processes and can be problematic due to their reactivity, leading to unwanted side reactions in the steam reformer. Carboxylic acids can be formed during oxidation reactions in the hydroprocessing and cause corrosion in the steam reformer as well as leading to unwanted side reactions. Esters can also be formed in the hydroprocessing and carried over; these can decompose to form alcohols and carboxylic acids.

In an embodiment, step i-5) further comprises conducting at least a portion of the overhead gas stream and/or at least a portion of the second liquid stream to a hydrodeoxygenation (HDO) step in a HDO reaction zone.

Thus, optionally, any remaining oxygenates may also be removed in the vapor and/or liquid of the second separation unit, e.g. cold separator.

In an embodiment, the liquid oil stream is a pyrolysis oil stream or a hydrothermal liquefaction oil (HTL oil) stream.

The pyrolysis oil stream or HTL oil stream has an oxygen (O) content of 5-50 wt %.

In a particular embodiment, the process comprising a prior step of thermal decomposition of a solid renewable feedstock for producing said liquid oil stream, wherein the thermal decomposition step is:
pyrolysis, such as fast pyrolysis, thereby producing said pyrolysis oil stream; or
hydrothermal liquefaction, thereby producing said HTL oil stream.

As used herein, the term “thermal decomposition” shall for convenience be used broadly for any decomposition process, in which a material is partially decomposed at elevated temperature (typically 250° C. to 800° C. or even 1000° C.), in the presence of sub-stoichiometric amount of oxygen (including no oxygen). The product will typically be a combined liquid and gaseous stream, as well as an amount of solid char. The term shall be construed to include processes known as pyrolysis and hydrothermal liquefaction, both in the presence and absence of a catalyst.

Accordingly, in a particular embodiment, the thermal decomposition is pyrolysis, such as fast pyrolysis, as defined farther below, thereby producing said pyrolysis oil stream.

It would be understood that the thermal decomposition is carried out in a thermal decomposition section. Hence, the pyrolysis is carried out in a pyrolysis section, and the hydrothermal liquefaction is carried out in a hydrothermal liquefaction section.

The term “section” means a physical section comprising a unit or combination of units for carrying out one or more steps and/or sub-steps.

For the purposes of the present invention, the pyrolysis section generates two main streams, namely a pyrolysis off-gas stream and a pyrolysis oil stream. The pyrolysis section may be in the form of a fluidized bed, transported bed, or circulating fluid bed, as is well known in the art. For instance, the pyrolysis section may comprise a pyrolyser unit (pyrolysis reactor), cyclone(s) to remove particulate solids such as char, and a cooling unit for thereby producing said pyrolysis off-gas stream and said pyrolysis oil stream, i.e. condensed pyrolysis oil. The pyrolysis off-gas stream comprises light hydrocarbons e.g. C1-C4 hydrocarbons, CO and CO₂. The pyrolysis oil stream is also referred as bio-oil and is a liquid substance rich in blends of molecules usually consisting of more than two hundred different compounds including aldehydes, ketones and/or other compounds such as furfural having a carbonyl group, resulting from the depolymerisation of products treated in pyrolysis.

For the purposes of the present invention, the pyrolysis is preferably fast pyrolysis, also referred in the art as flash pyrolysis. Fast pyrolysis means the thermal decomposition of a solid renewable feedstock in the absence of oxygen, at temperatures in the range 350-650° C. e.g. about 500° C. and reaction times of 10 seconds or less, such as 5 seconds or less, e.g. about 2 sec. Fast pyrolysis may for instance be carried out by autothermal operation e.g. in a fluidized bed reactor. The latter is also referred as autothermal pyrolysis and is characterized by employing air, optionally with an inert gas or recycle gas, as the fluidizing gas, or by using a mixture of air and inert gas or recycle gas.

In an embodiment, the thermal decomposition is hydrothermal liquefaction. Hydrothermal liquefaction means the thermochemical conversion of biomass into liquid fuels by processing in a hot, pressurized water environment for sufficient time to break down the solid bio-polymeric structure to mainly liquid components. Typical hydrothermal processing conditions are temperatures in the range of 250-375° C. and operating pressures in the range of 40-220 bar. This technology offers the advantage of operation of a lower temperature, higher energy efficiency and lower tar yield compared to pyrolysis, e.g. fast pyrolysis. For details on hydrothermal liquefaction of biomass, reference is given to e.g. Golakota et al., “A review of hydrothermal liquefaction of biomass”, Renewable and Sustainable Energy Reviews, vol. 81, Part 1, January 2018, p. 1378-1392.

In an embodiment, the thermal decomposition further comprises passing said solid renewable feedstock through a solid renewable feedstock preparation section comprising for instance drying for removing water and/or comminution for reduction of particle size. Any water/moisture in the solid renewable feedstock which vaporizes in for instance the pyrolysis section condenses in the pyrolysis oil stream and is thereby carried out in the process, which may be undesirable. Furthermore, the heat used for the vaporization of water withdraws heat which otherwise is necessary for the pyrolysis. By removing water and also providing a smaller particle size in the solid renewable feedstock the thermal efficiency of the pyrolysis section is increased.

In an embodiment, the solid renewable feedstock is a lignocellulosic biomass including: wood products, forestry waste, and agricultural residue. In another embodiment, the solid renewable feedstock is municipal waste, in particular the organic portion thereof. The municipal waste is herein defined as a feedstock containing materials of items discarded by the public, such as mixed municipal waste given the waste code 200301 in the European Waste Catalog. In another embodiment, the solid renewable feedstock is any of sewage sludge, used tires, algae, and plastic materials.

In a particular embodiment, the lignocellulosic biomass is forestry waste and/or agricultural residue and comprises biomass originating from plants including grass such as nature grass (grass originating from natural landscape), wheat e.g. wheat straw, oats, rye, reed grass, bamboo, sugar cane or sugar cane derivatives such as bagasse, maize and other cereals.

Any combinations of the above is also envisaged.

As used herein, the term “lignocellulosic biomass” means a biomass containing, cellulose, hemicellulose and optionally also lignin. The lignin or a significant portion thereof may have been removed, for instance by a prior bleaching step.

In a second general embodiment according to a first aspect of the invention, there is also provided a process for producing a hydrocarbon product, said process comprising the steps of:
i) conducting a liquid oil stream to a hydroprocessing step for producing a first and second liquid hydrotreated streams, said hydroprocessing step comprising:
i-1) optionally, conducting the liquid oil stream to a stabilization step in a stabilization reaction zone for producing a stabilized liquid oil stream;
i-2) conducting the liquid oil stream, or the optional stabilized liquid oil stream, to a first hydrodeoxygenation (HDO) step in a HDO reaction zone for producing a first hydrotreated stream;
i-3) conducting the first hydrotreated stream to a first separation unit for splitting said first hydrotreated stream into a vapor stream and said first liquid hydrotreated stream;
i-4) conducting the vapor stream to a second hydrodeoxygenation (HDO) step in a HDO reaction zone for producing a second hydrotreated stream;
i-5) cooling the second hydrotreated stream for providing a cooled second hydrotreated stream, conducting the cooled second hydrotreated stream to a second separation unit and separating therefrom at least an overhead gas stream and said second liquid hydrotreated stream;
i-6) optionally, combining the first liquid hydrotreated stream with the second liquid hydrotreated stream into a main hydrotreated stream;
ii) separating from the first or second liquid hydrotreated stream, optionally from said main hydrotreat stream, said hydrocarbon product.

Any of the embodiments and associated benefits of the first general embodiment according to the first aspect of the invention may be used together with the second general embodiment according to the first aspect of the invention, or vice versa.

In a second aspect of the invention, there is also provided a plant (system) for carrying out the process according to any of the above embodiments. The plant comprises:
optionally, a stabilization reaction zone arranged to receive a liquid oil stream and provide a stabilized liquid oil stream;
a first hydrodeoxygenation (HDO) reaction zone arranged to receive a liquid oil stream or the optional stabilized liquid oil stream, and provide a first hydrotreated stream;
a first separation unit arranged to receive the first hydrotreated stream and provide: a vapor stream and a first liquid hydrotreated stream;
a second hydrodeoxygenation (HDO) reaction zone arranged to receive the vapor stream and provide a second hydrotreated stream;
a cooling unit, such as an air cooler, arranged to receive the second hydrotreated stream and provide a cooled second hydrotreated stream; a second separation unit arranged to receive the cooled second hydrotreated stream and provide: an overhead gas stream and a second liquid hydrotreated stream;
optionally, a mixing point, such as a juncture, arranged to combine the first liquid hydrotreated stream with the second liquid hydrotreated stream into a main hydrotreated stream;
a separation section arranged to receive the first or second liquid hydrotreated stream, optionally arranged to receive said main hydrotreated stream; and separating therefrom a hydrocarbon product.

Any of the embodiments and associated benefits of the first or second general embodiment according to the first aspect of the invention may be used together with the second aspect of the invention, or vice versa.

The sole appended figure shows a schematic layout of the process and plant according to an embodiment of the invention.

With reference to the figure, a process and plant 10 is shown, where a liquid oil stream 1, suitably a pyrolysis oil stream or HTL oil stream, is combined with overhead recycle stream 3, thereby forming liquid oil stream 1′ and which is then preheated in a heat exchanger to provide preheated liquid oil stream 1″. The preheated stream 1″ is conducted to an optional stabilization reaction zone 12′, here illustrated as a stabilization reactor comprising a catalytic fixed bed, thereby producing a stabilized liquid oil stream 5. The stabilized liquid oil stream 5 is cooled in a heat exchanger to provide liquid oil stream 5′, which is then conducted to an additional optional stabilization reaction zone 12″, thereby producing stabilized liquid oil stream 5″. This stream is then preheated in a feed/effluent heat exchanger of main HDO reaction zone 14 utilizing first hydrotreated stream 7 as heat exchanging medium, thus providing preheated stream 5″, which is further preheated in fired heater 16′ to provide preheated stabilized liquid oil stream 5^{iv}. The cooled first hydrotreated stream 7′ is conducted to a first separation unit 18, such as a hot separator, for splitting said first hydrotreated stream 7, 7′ into a vapor stream 9 and a first liquid hydrotreated stream 11. A portion 11′ of the first liquid hydrotreated stream 11 is suitably recycled to main HDO reaction zone 14. The vapor stream 9 is preheated in a feed/effluent heat exchanger of vapor HDO reaction zone 20 utilizing second hydrotreated stream 13 as heat exchanging medium, thus providing preheated stream 9′, which is further preheated in fired heater 16″ to provide preheated vapor stream 9″. A common (single) fired heater 16′ may for instance be provided instead, for preheating the feed to main HDO reaction zone 14 and preheating the feed to vapor HDO reaction zone 20.

The second hydrotreated stream 13 is thus cooled to form stream 13′, admixed with water stream 15′ provided as wash-water from a water stream 15 withdrawn from second separation unit 22, e.g. a cold separator. After said admixing, the second hydrotreated stream 13″ is cooled to stream 13′″ in air cooler, as shown in the figure, and conducted to the second separation unit 22. From the bottom water stream 15, a portion is also withdrawn as sour water 15″ having a low content of oxygenates and thus further treated in a waste-water treatment plant (not shown). From the second separation unit 22 an overhead gas stream 21 is withdrawn, as so is a second liquid hydrotreated stream 17. The latter is withdrawn e.g. as stream 17′ and combined with first liquid hydrotreated stream 11″, thereby forming main hydrotreated stream 19. Hydrocarbon products such as naphtha, diesel and jet fuel are then separated in a downstream product recovery section (not shown) from the main hydrotreated stream 19. Hydrocarbons may also be separated independently from the first 11, 11″ and second 17, 17′ liquid hydrotreated streams. For instance, a portion 17″ of the second liquid hydrotreated stream 17 is conducted to a separation section 24 comprising a product stripper and fractionation unit (not shown) for producing a naphtha stream, of which at least a portion 23 is provided as hydrocarbon feed (hydrocarbon fuel) source to hydrogen producing unit (HPU) 26. An LPG stream (not shown) may also be withdrawn in section 24 and provided to HPU 26. An off-gas stream 21′ is divided from the overhead gas stream 21 and provided as hydrocarbon feed (fuel) to the HPU 26. A minor amount of externally sourced natural gas 27 may also be provided. The HPU comprises a steam reforming unit, suitably an electrically heated steam reformer (e-SMR, not shown), and produces make-up hydrogen stream 25. The make-up hydrogen 25 is suitably admixed via compressor 28′ as compressed make-up hydrogen stream 25′ to another portion 21″ of the overhead gas stream 21. Thereby, via recycle compressor 28″, the overhead recycle stream 3 is combined with the liquid oil stream 1 being fed to the process and plant 10.

### EXAMPLE

### Prior Art:

“Base case” is a conventional process and plant without the vapor HDO. In the appended figure, it corresponds to removal (absence) of HDO reaction zone 20, i.e. the HDO reactor 20, and associated heater 16″ and heat exchanger. Process line (or conduit) 9 is connected directly to process line 13′ and mixing point with the wash water 15′ and subsequent air cooler.

### Invention:

“With reactor” is the performance of the process and plant as shown in the appended figure, thus according to the present invention.

The following table shows the performance. The associated process lines (Stream #) of refer to the figure:

Base case

| | | | | | |
|---|---|---|---|---|---|
| Stream | Feed | HHPS vap | CHPS vap | CHPS W | CHPS Liq |
| Stream# | 1 | 9 | 21 | 15″ | 17 |
| C5 and | 100 | 8.38 | 0.23 | 1.13 | 7.03 |
| heavier (mass) | | | | | |

With reactor

| | | | | | |
|---|---|---|---|---|---|
| Stream | Feed | HHPS vap | CHPS vap | CHPS W | CHPS Lig |
| Stream# | 1 | 9 | 21 | 15″ | 17 |
| C5 and | 100 | 8.36 | 0.20 | 0.20 | 7.95 |
| heavier (mass) | | | | | |

“HHPS vap” stands for hot high pressure separator vapor. In the appended figure this corresponds to first separation unit 18, with associated process line 9.

“CHPS vap” stands for cold high pressure separator vapor. In the appended figure this corresponds to second separation unit 22, with associated process line 21.

“CHPS W” stands for cold high pressure separator water. In the appended figure this corresponds to second separation unit 22, with associated process line 15″.

“CHPS Liq” stands for cold high pressure separator liquid. In the appended figure this corresponds to second separation unit 22, with associated process line 17.

“C5 and heavier (mass)” is the amount of heavy hydrocarbons (C5+), relative to the amount of feed. This is what is often referred to in the art as wt % of feed flow, or wt % FF.

In the “Base case” there is a loss of 1.13 wt % FF in the water (CHPS W). Hence, the yield difference being 1-2 wt % total liquid product.

In contrast, in the “With reactor” case according to the present invention, there is only a loss of 0.20 wt % FF, hence a saving of 0.93 wt % FF.

The CHPS liquid is increased by 0.92 wt % FF, which is recovered in the final liquid product. Hence, the amount of desired heavy hydrocarbons (C5+) in a final liquid product (liquid hydrotreated stream 17) is significantly increased, e.g. to more than 10%, here specifically 13% ((7.95−7.03)/7.03×100)).

Furthermore, by not sending any oxygenates to the hydrogen producing unit (HPU, 26) via overhead stream 21, the performance and process economy of the HPU is improved. The oxygenate components are harmful to a steam reformer of the HPU, thus requiring expensive cleaning, i.e. higher capital and operating expenditures, prior to being introduced to the steam reformer. Lower content of oxygenates in line 15″ results also in wastewater that is easier to treat in a wastewater treatment plant.

1. A process for producing a hydrocarbon product, said process comprising the steps of:
i) conducting a liquid oil stream to a hydroprocessing step for producing a first liquid hydrotreated stream and a second liquid hydrotreated stream, said hydroprocessing step comprising:
i-1) optionally conducting the liquid oil stream to a stabilization step in a stabilization reaction zone for producing a stabilized liquid oil stream;
i-2) conducting the liquid oil stream, or the optional stabilized liquid oil stream, to a first hydrodeoxygenation (HDO) step in a HDO reaction zone for producing a first hydrotreated stream;
i-3) conducting the first hydrotreated stream to a first separation unit for splitting said first hydrotreated stream into a vapor stream and said first liquid hydrotreated stream;
i-4) conducting the vapor stream to a second hydrodeoxygenation (HDO) step in a HDO reaction zone for producing a second hydrotreated stream;
i-5) cooling the second hydrotreated stream for providing a cooled second hydrotreated stream, conducting the cooled second hydrotreated stream to a second separation unit and separating therefrom at least an overhead gas stream and said second liquid hydrotreated stream;
i-6) optionally, combining the first liquid hydrotreated stream with the second liquid hydrotreated stream into a main hydrotreated stream;
ii) separating from the first or second liquid hydrotreated stream, optionally from said main hydrotreated stream, said hydrocarbon product.

2. The process according to claim 1, wherein the first separation unit is a hot separator and/or a stripping unit, and the second separation unit is a cold separator.

3. The process according to claim 1, further comprising:
dividing a portion of the overhead gas stream of the step i-5) as an off-gas stream and supplying the off-gas stream to a hydrogen producing unit (HPU) comprising a reforming unit, for producing a make-up hydrogen stream; and/or
recycling another portion of the overhead gas stream of the step i-5), optionally in admixture with at least a portion of make-up hydrogen stream, to any of: the optional stabilization reaction zone of the step i-1), the HDO reaction zone of the step i-2), the HDO reaction zone of strep i-4), or combinations thereof.

4. The process according to claim 3, wherein the another portion of the overhead gas stream of the step i-5), optionally in admixture with at least a portion of make-up hydrogen stream, is directly recycled to any of: the optional stabilization reaction zone of the step i-1), the HDO reaction zone of the step i-2), the HDO reaction zone of strep i-4), or combinations thereof.

5. The process according to claim 3, wherein the reforming unit of said HPU is an electrically heated steam methane reformer (e-SMR).

6. The process according to claim 1, further comprising:
preheating in the step i-2) the optional stabilized liquid oil stream to an inlet temperature of said HDO reaction zone in a fired heater;
preheating in the step i-4) the vapor stream to the inlet temperature of said HDO reaction zone in a fired heater;
wherein said preheating of the optional stabilized liquid oil stream and said preheating of the vapor stream are performed in a same fired heater.

7. The process according claim 1 further comprising:
preheating in the step i-2) the optional stabilized liquid oil stream to an inlet temperature of said HDO reaction zone in an electrical heater; and/or
preheating in the step i-4) the vapor stream to the inlet temperature of said HDO reaction zone by heat exchange with the first hydrotreated stream of the step i-2).

8. The process according to claim 1, wherein the step i-5) comprises separating a water stream from the second separation unit, admixing a portion of the water stream as wash-water with the second hydrotreated stream, and conducting the second hydrotreated stream to a cooling unit for providing said cooled second hydrotreated stream, prior to said cooled second hydrotreated stream being introduced to the second separation unit.

9. The process according to claim 1, wherein the step i-5) further comprises conducting at least a portion of the overhead gas stream and/or at least a portion of the second liquid hydrotreated stream to a hydrodeoxygenation (HDO) step in a HDO reaction zone.

10. The process according to claim 1, wherein the liquid oil stream is a pyrolysis oil stream or a hydrothermal liquefaction oil (HTL oil) stream.

11. The process according to claim 10, further comprising a prior step of thermal decomposition of a solid renewable feedstock for producing said liquid oil stream, wherein the thermal decomposition step is:
pyrolysis, thereby producing said pyrolysis oil stream; or
hydrothermal liquefaction, thereby producing said HTL oil stream.

12. A plant for carrying out the process of claim 1, comprising:
optionally, a stabilization reaction zone arranged to receive a liquid oil stream and provide a stabilized liquid oil stream;
a first hydrodeoxygenation (HDO) reaction zone arranged to receive a liquid oil stream or the optional stabilized liquid oil stream, and provide a first hydrotreated stream;
a first separation unit arranged to receive the first hydrotreated stream and provide: a vapor stream and a first liquid hydrotreated stream;
a second hydrodeoxygenation (HDO) reaction zone arranged to receive the vapor stream and provide a second hydrotreated stream;
a cooling unit arranged to receive the second hydrotreated stream and provide a cooled second hydrotreated stream; a second separation unit arranged to receive the cooled second hydrotreated stream and provide an overhead gas stream and a second liquid hydrotreated stream;
optionally, a mixing point arranged to combine the first liquid hydrotreated stream with the second liquid hydrotreated stream into a main hydrotreated stream;
a separation section arranged to receive the first or second liquid hydrotreated stream, optionally arranged to receive said main hydrotreated stream; and arranged to separate therefrom a hydrocarbon product.

13. The process according to claim 1, comprising, in the hydroprocessing step, the conducting of the liquid oil stream to the stabilization step in the stabilization reaction zone for producing the stabilized liquid oil stream, and the conducting of the stabilized liquid oil stream to the first HDO step in the HDO reaction zone for producing the first hydrotreated stream.

14. The plant according to claim 12, comprising the stabilization reaction zone arranged to receive the liquid oil stream and provide the stabilized liquid oil stream, wherein the first HDO reaction zone is arranged to receive the stabilized liquid oil.

15. The process according to claim 1, comprising, in the hydroprocessing step, the combining of the first hydrotreated stream with the second liquid hydrotreated stream into the main hydrotreated stream, and comprising the separating of the hydrocarbon product from the main hydrotreated stream.

16. The plant according to claim 12, comprising the mixing point arranged to combine the first liquid hydrotreated stream with the second liquid hydrotreated stream into the main hydrotreated stream, wherein the separation section is arranged to receive the main hydrotreated stream and is arranged to separate therefrom the hydrocarbon product.
